(19) United States
(12) Patent Application Publication
(10) Pub. No.: US 2026/0098775 A1
(43) Pub. Date: Apr. 9, 2026

(54) COMBINED PRESSURE TEMPERATURE TEST EQUIPMENT

(71) Applicant: Oceaneering International, Inc., Houston, TX (US)

(72) Inventor: Ashish NEGI, Punjab (IN)

(73) Assignee: Oceaneering International, Inc., Houston, TX (US)

(21) Appl. No.: 19/346,293

(22) Filed: Sep. 30, 2025

(30) Foreign Application Priority Data
Oct. 4, 2024 (IN) 202411075000

(51) Int. Cl. G01L 19/00

(52) U.S. Cl. CPC G01L 19/0092; G01L 2019/0053

(57) ABSTRACT

Test chamber 4 is the main work area wherein all the control parameters, e.g., pressure and temperature, are controlled as per the defined parameters. Non-pneumatic pressurizer 100 may operate as a high pressure pumping unit with forward and backward pressure regulation, works with PLC 140 and uses feedback from a pair of pressure transducers 130,132 to control pressurization and de-pressurization rate as per the defined parameters and also regulates pressure inside test chamber 4 corresponding to heat generated inside test chamber 4 because of heat generated from test equipment.

### CROSS-REFERENCE TO RELATED APPLICATIONS

This application claims priority through United States Provisional Application 202411071000 filed on Oct. 4, 2024, incorporated herein by reference.

### BACKGROUND OF THE INVENTION

A problem needing to be solved is the ability to test a product while being submerged for prolonged duration at high hydraulic pressure, at different set temperature of test fluid. If tests are performed separately, it is challenging and often misleading to draw a co-relation matrix and estimate their combined effect. The number of tests run to have sufficient data to draw any co-relation would be too many, while with developed test set-up same can be evaluated in less test-runs.

### BRIEF DESCRIPTION OF DRAWINGS

Various figures are included herein which illustrate aspects of embodiments of the disclosed inventions.

FIG. 1 is a cutaway view in partial perspective of an exemplary combined pressure/temperature tester 1; and

FIG. 2 is a cutaway and diagrammatic view in partial perspective of system using an exemplary combined pressure/temperature tester 1.

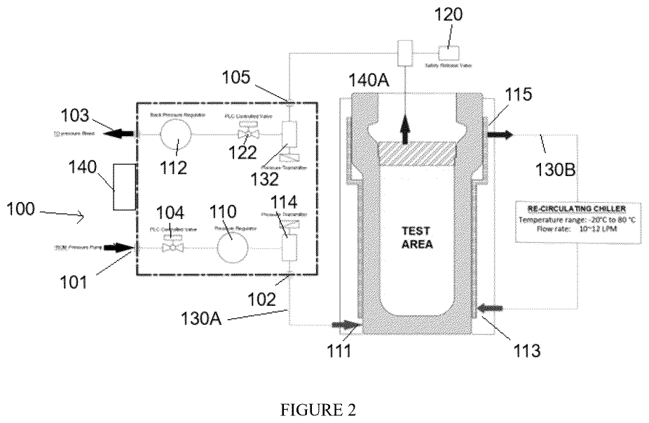

### DETAILED DESCRIPTION OF EMBODIMENTS OF THE INVENTION

The claimed invention uses a combination of two systems working together to maintain pressure and temperature parameters simultaneously. In addition, the claimed invention comprises an additional ability to sustain test pressure, pressure ramp-up and ramp-down cycle sequences with predefined parameters along with a heat source inside test chamber 4, and maintain pressure and temperature test parameters within a defined set of one or more parameters'ranges.

As a testing requirement may be for prolonged periods of up to 90 days, dependability on power to run a high pressure pumping system is kept to minimum and is only utilized to run programmable logic controller (PLC) 140. Typically, all pumping systems and controls are run through pneumatics. Using the system, either system temperature or pressure can be regulated and/or varied while the other is kept within set defined limits.

For temperature control, various options used for cooling and/or heating the test fluid inside the closed chamber may be used, e.g.:
a. test chamber 4 is submerged in a tank filled with fluid (e.g., ethylene/water/glycol) which is being cooled and/or heated as required to further maintain temperature of fluid inside test chamber 4 by heat transfer through conduction and convection;
b. heating coils wrapped around to heat test chamber 4 and subsequently the fluid inside; and
c. using a pillow plate heat exchanger for heating and/or cooling on flat or circular profiles.

For pressure control also there are various methods that can be utilized, e.g.:
d. defining the set pressure, with defined controls through pressure regulators.
e. defining the ramp-up sequence cycle with HMI controls

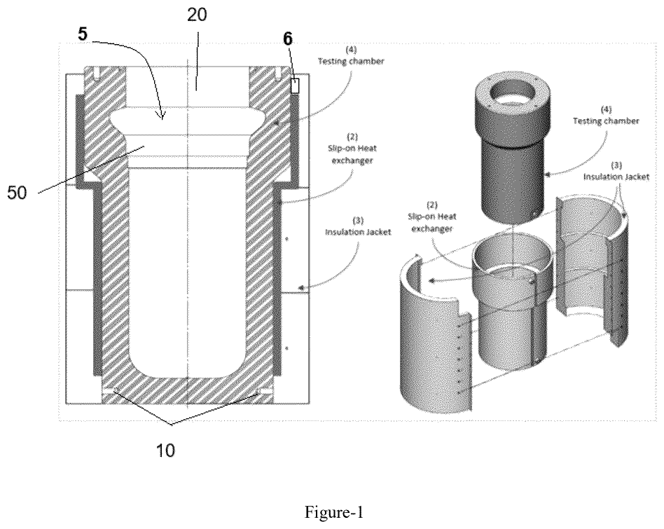

In a first embodiment, referring generally to FIG. 1, combined pressure/temperature tester 1 comprises testing chamber 4 comprising a plurality of fluid inputs 10 and a plurality of fluid outputs 20; slip-on heat exchanger 2 configured to fit about a predetermined outer surface of testing chamber 4 where heat exchanger 2 is operative to maintain a predetermined pressure and heat within testing chamber 4; one or more electric circulating fans 5 disposed within test chamber 4 to provide fluid flow, e.g., turbulence, inside testing chamber with respect to pressurized fluid therein to increase heat transfer rate and evenly distribute heating and/or cooling; one or more electrical interfaces 6 operatively connected to electric circulating fans 5; and insulator 3 configured to fit about a predetermined outer surface of slip-on heat exchanger 2. In embodiments, testing chamber 4, slip-on heat exchanger 2, and insulator 3 are substantially tubular but other configurations are possible, by way of example and not limitation oval or obround.

In embodiments, non-pneumatic pressurizer 100 is present and operatively in communication with first fluid path 130A of a plurality of fluid paths 130 defined by a fluid pathway from a first fluid input 111 of the plurality of fluid inputs 10, where non-pneumatic pressurizer 100 is configured to provide high pressure pumping, by way of example and not limitation of around 15,000 psi (1,034 bar). In embodiments, a pressurizing medium such as hydraulic oil, with forward and backward pressure regulation working with a programmable logic controller (PLC) and feedback from a pair of pressure transducers 110,112 to control the pressurization and de-pressurization rate. Safety release valve 120 is typically operatively in communication with non-pneumatic pressurizer 100 and with second fluid path 130B of the plurality of fluid paths 130 defined by a fluid pathway from first fluid output 140A of a plurality of fluid outputs 140.

In embodiments, non-pneumatic pressurizer 100 comprises first fluid input 101; first fluid output 102 operatively in fluid communication with first fluid path 130A; second fluid output 103; first valve 104 operatively in fluid communication with first fluid input 101 and configured to be operable under continuous power; first pressure regulator 110 operatively in fluid communication with first valve 104; first pressure transmitter 114 operatively in fluid communication with first pressure regulator 110 and with first fluid output 102; second fluid input 105 operatively in fluid communication with safety release valve 120; second pressure transmitter 132 operatively in fluid communication with second fluid input 105; second valve 122 operatively in fluid communication with second pressure transmitter 132 and configured to be operable under continuous power; and second pressure regulator 112 operatively in fluid communication with second valve 122 and second fluid output 103. In embodiments, first valve 104 and second valve 112 comprise a controlled valve which may comprise a programmable logic controller (PLC) controlled valve. Second fluid pathway 130B typically exists between second fluid input 113 of the plurality of fluid inputs and second fluid output 115 of the plurality of fluid outputs. In typical embodiments, second fluid pathway 130B defines a re-circulating chiller configured to maintain a constant supply of fluid to transfer heat from 4 test chamber with heat exchanger 2 to enable energy transfer through conduction and comprises a heat transfer fluid, e.g., ethylene glycol.

In embodiments, heat exchanger 2 comprises 1 mm of 316L stainless steel.

In embodiments, insulator 3 comprises an insulation jacket which may comprise a predetermined number of insulating layers.

In the operation of exemplary methods, referring back to FIG. 1, temperature within test chamber 4 may be controlled such as by utilizing heat source 50 disposed inside test chamber 4 and maintaining pressure and temperature test parameters within a predefined parameter range. Electric circulating fans 5 inside test chamber 4 may be used to provide flow, e.g., turbulence, inside pressurized fluid in test chamber 4 to increase heat transfer rate and evenly distribute heating and/or cooling.

As will be apparent to one of ordinary skill, the claimed invention, in its embodiments, can be a single setup that can meet testing criteria of temperature and pressure to meet several needs to test individually or in combination. In its embodiments, combined pressure/temperature tester 1 can provide a re-circulating chiller, with temperature range of −20° C.˜80° C., and flow rate of 10˜12 lpm to provide heating and/or cooling fluid, by using second fluid pathway 130B.

The claimed invention is different in terms of packaging and interfacing all the elements together and by effectively being able to monitor and control the same with PLC 140. Working together, re-circulating chiller defined by second fluid pathway 130B, which maintains a constant supply of fluid to transfer heat from test chamber 4, by cycling a fluid, e.g., ethylene glycol, to heat exchanger 2 which, in turn, is wrapped around test chamber 4, to enable energy transfer through conduction; slip-on heat exchanger 4, which may comprise 1 mm of 316L stainless steel, provides a wraparound periphery around test chamber 4 and, with fluid from the re-circulating chiller constantly running through it, heat exchanger 2 extracts heat and/or provides heat to maintain temperature of a working fluid inside test chamber 4; insulator 3 provides one or more layers of insulation on an external surface of heat exchanger 2 to keep energy loss to a minimum and ensuring to achieve the require temperature differential; and electric circulating fans 5 disposed inside test chamber 4 help circulate pressurized fluid. These all can work together to help ensure that an effective delta of around 10° C. is effectively maintained with respect to what is being supplied from chiller 130B and the temperature of fluid inside test chamber 4 while considering differing kinds of energy and efficiency losses.

Generally, test chamber 4 is the main work area wherein all the control parameters, e.g., pressure and temperature, are controlled as per the defined parameters. Non-pneumatic pressurizer 100 may operate as a high pressure pumping unit with forward and backward pressure regulation, works with PLC 140 and uses feedback from a pair of pressure transducers 130,132 to control pressurization and de-pressurization rate as per the defined parameters and also regulates pressure inside test chamber 4 corresponding to heat generated inside test chamber 4 because of heat generated from test equipment.

As desired, a low dependency for a pressure control system may comprise using power with only PLC 140 running on continuous power with all other pumps and valves being run pneumatically to enable a test run for a longer hold period.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1) A combined pressure/temperature tester, comprising:
a) a testing chamber comprising a plurality of fluid inputs and a plurality of fluid outputs.
b) a slip-on heat exchanger configured to fit about a predetermined outer surface of the testing chamber, the heat exchanger operative to maintain a predetermined pressure and heat within the testing chamber;
c) an electric circulating fan disposed within the test chamber to provide flow (turbulence) inside chamber's pressurized fluid to increase heat transfer rate and evenly distributed heating and/or cooling;
d) an electrical interface operatively connected to the electric circulating fan; and
e) an insulator configured to fit about a predetermined outer surface of the slip-on heat exchanger.

2) The combined pressure/temperature tester of claim 1, wherein the testing chamber, slip-on heat exchanger, and insulator are substantially tubular.

3) The combined pressure/temperature tester of claim 1, further comprising:
a) a non-pneumatic pressurizer operatively in communication with a first fluid path of the plurality of fluid paths defined by a fluid pathway from a first fluid input of the plurality of fluid inputs, the non-pneumatic pressurizer configured to provide high pressure pumping of around 15,000 psi (1,034 bar)[, pressurizing medium˜hydraulic oil, with forward and backward pressure regulation, working with PLC and feedback from pair of Pressure Transducer] to control the pressurization and de-pressurization rate; and
b) a safety release valve operatively in communication with the pressurizer and with a second fluid path of the plurality of fluid paths defined by a fluid pathway from a first fluid ouput of the plurality of fluid outputs.

4) The combined pressure/temperature tester of claim 3, wherein the pressurizer comprises:
a) a first fluid input;
b) a first fluid output operatively in fluid communication with the first fluid path;
c) a second fluid output;
d) a first valve operatively in fluid communication with the first fluid input and configured to be operable under continuous power;
e) a first pressure regulator operatively in fluid communication with the first valve;
f) a first pressure transmitter operatively in fluid communication with the first pressure regulator and with the first fluid output;
g) a second fluid input operatively in fluid communication with the safety release valve;
h) a second pressure transmitter operatively in fluid communication with the second fluid input;
i) a second valve operatively in fluid communication with the second pressure transmitter and configured to be operable under continuous power; and
j) a second pressure regulator operatively in fluid communication with the second valve and the second fluid output.

5) The combined pressure/temperature tester of claim 4, wherein the first valve and the second valve comprise a controlled valve.

6) The combined pressure/temperature tester of claim 5, wherein the controlled valve comprises a programmable logic controller (PLC) controlled valve operatively connected to a PLC.

7) The combined pressure/temperature tester of claim 1, further comprising a second fluid pathway between a second fluid input of the plurality of fluid inputs and a second fluid output of the plurality of fluid outputs.

8) The combined pressure/temperature tester of claim 7, wherein the second fluid pathway defines a re-circulating chiller configured to maintain a constant supply of fluid to transfer heat from the test chamber with the heat exchanger to enable energy transfer through conduction and comprises a heat transfer fluid.

9) The combined pressure/temperature tester of claim 8, wherein the heat transfer fluid comprises ethylene glycol.

10) The combined pressure/temperature tester of claim 1, wherein the heat exchanger comprises 1 mm of 316L stainless steel.

11) The combined pressure/temperature tester of claim 1, wherein the insulator comprises an insulation jacket comprising a predetermined number of insulating layers.
